(19) United States
(12) Patent Application Publication
(10) Pub. No.: US 2009/0295290 A1
(43) Pub. Date: Dec. 3, 2009

(54) METAL LEAD-THROUGH STRUCTURE AND LAMP WITH METAL LEAD-THROUGH

(75) Inventor: Istvan Magai, Karinthy (HU)

Correspondence Address: FAY SHARPE LLP, 1228 Euclid Avenue, 5th Floor, The Halle Building, Cleveland, OH, 44115, US

(73) Assignee: General Electric Company

(21) Appl. No.: 12/131,499

(22) Filed: Jun. 2, 2008

(51) Int. Cl. H01J 17/18; H02G 3/04

(52) U.S. Cl. 313/623; 174/68.1

(57) ABSTRACT

A metal lead-through structure being embedded in an embedding material and operating in a temperature range is suggested. The metal lead-through has a start point and an end point, and comprises elementary sections enclosing an angle between each other. The elementary sections have a length smaller than the length leading to a thermal expansion difference between the metal lead-through and the embedding material developing a break in the embedding material. The elementary sections are connected to and enclose an angle magnitude between each other so that a sum of the thermal expansions thereof taken in a direction determined by a straight line drawn between the start point and the end point of the metal lead-through is smaller than the expansion developing a break in the embedding material. A lamp comprising the metal lead-through structure is also suggested.

### FIELD OF THE INVENTION

This invention relates to a metal lead-through structure, especially for lamps operating at high temperatures. More specifically, the invention relates to a metal lead-through construction for a lamp with a pinched end seal and at least one lead wire led through the seal.

### BACKGROUND OF THE INVENTION

Lamps generally have a light source enclosed in a protective envelope and lead wires for connecting the light source to an external power supply. The lamp envelopes may have very different shapes but each of them has at least one sealed end section with the lead wires led through the sealed end section. The lamp envelopes, also comprising the sealed end portion, are generally made of glass and comprise lead wires of metal. The light sources develop a certain amount of heat that leads to thermal expansion of the parts exposed to that heat. Different parts made of different materials have generally different thermal expansion coefficients and expand to a different extent when exposed to heat. The higher the temperature of the lamp, the larger the expansion of the parts under heat. As the different parts expand to a different extent, the different expansion of the parts directly contacting each other experience a mechanical stress caused by the thermal expansion difference. The higher the temperature and the higher the difference in thermal expansion coefficient of the different parts being in direct contact, the higher the mechanical stress resulting in cracks in the glass material of the sealed end portion. These cracks, if propagate in time to the outer surface of the glass material of the sealed end portion, terminate the life of the lamp.

In order to reduce the mechanical stress at higher temperatures, the glass material and the metal lead wire are selected so as to have thermal expansion coefficients as close as possible to each other. When using hard glass for manufacturing lamp envelopes with a pinched end seal, differences between the coefficients of the glass material and the lead wire of molybdenum or tungsten are small. Hard glass, such as a borosilicate glass, aluminosilicate glass or the like, has a typical thermal expansion coefficient value of 3.5 ppm/K. This value is 4.5 ppm/K for tungsten and 4.8 ppm/K for molybdenum. Because of the small difference between the coefficients of the hard glass material and the lead wire of molybdenum or tungsten, the lead wire may be led through the pinched end seal of the lamp tube or envelope without any additional means as disclosed in U.S. Pat. No. 4,178,050. Hard glass however has a higher softening temperature and therefore its manufacturing requires more heat energy that results in higher production costs.

Therefore, fused silica (or quartz) is typically used for forming glass tubes or envelopes for lamps. Quartz glass has a lower softening temperature resulting in a more cost effective manufacturing process. This glass material provides an extremely low value for the thermal expansion coefficient of 0.55 ppm/K, which makes it suitable for using in a high temperature range without thermal or mechanical stress in the glass material. The higher difference between the coefficients of the quartz glass material and the lead wire of molybdenum or tungsten however makes it necessary to use a molybdenum foil in the pinched end seal of the lamp, which is often designated as a seal foil. The seal foil is welded to the lead wires and this welded structure is than held by the pinched end seal. Even in that case the glass material of the lamps is subject to break when exposed to high temperature during operation.

U.S. Pat. No. 6,992,446 discloses a halogen lamp of a 12V type including: a glass part, a portion of which is a light emitting portion having a space therein and the rest of which is a sealing portion, both portions being made of quartz glass; an infrared reflective coating formed to cover an outer surface of the glass part; a filament which, supported by the sealing portion, is provided in the inner space of the light emitting portion; a molybdenum foil which is embedded in the sealing portion and is electrically connected to the filament; and a power supply line, one end of which is connected to the molybdenum foil, the other end exposed to outside.

U.S. Pat. No. 4,578,616 discloses single-ended tungsten halogen incandescent lamp having an improved mounting assembly for a planar multi-filament. The improved mounting assembly comprises, in part, means rigidly located in the pinch seal end of the lamp for coupling the outer lead-in wires to support rod members of the mounting assembly. The means for coupling comprises a first foil member and a first tab member, and a second foil member and a second tab member. The foil members and tab members are arranged with the outer lead-in wires and support rods to form a torsion bar-like configuration which holds the planar multi-filament in the central region within the lamp itself. The torsion bar-like configuration also finds application to lamps other than this tungsten halogen incandescent lamp. This lead wire, foil, filament structure and mount assembly with bridge members also results in a complicated and cost intensive configuration.

The higher the operation temperature of a special lamp, the higher is the risk of failure in the seal end, which may result in an early breakdown. Halogen lamps have operation temperatures in the range of 200 to 500° C. High Intensity Discharge lamps may have a plasma temperature of about 5000° C. and a temperature of the sealed end portion in the range of 400 to 600° C.

Thus, there is a particular need for a glass to metal seal structure for lamps which can be used at high operating temperatures, can be manufactured easily. does not require additional means or manufacturing steps for producing the lamp, especially in the case if fused silica (quartz glass) or ceramic material is used as a tube or envelope material of the lamp.

### SUMMARY OF THE INVENTION

In an exemplary embodiment of the present invention, there is provided a metal lead-through structure being embedded in an embedding material and operating in a temperature range, the metal lead-through having a start point and an end point, and comprising
elementary sections being connected to and enclosing an angle between each other;
the elementary sections having a length smaller than the length leading to a thermal expansion difference between the metal lead-through and the embedding material developing a break in the embedding material.

In a further exemplary embodiment of the invention, the elementary sections enclose an angle magnitude so that a sum of the thermal expansions thereof taken in a direction determined by a straight line drawn between the start point and the end point of the lead-through is smaller than the expansion developing a break in the embedding material.

In another exemplary embodiment of the present invention, there is provided a structure of a metal lead-through being embedded in an embedding material and operating in a temperature range, the metal lead-through having a start point and an end point, and comprising
elementary sections;
the elementary sections having a length smaller than the length leading to a thermal expansion difference between the metal lead-through and the embedding material developing a break in the embedding material; and
the elementary sections being connected to and enclosing an angle between each other so that a sum of the thermal expansions thereof taken in a direction determined by a straight line drawn between the start point and the end point of the metal lead-through is smaller than the expansion developing a break in the embedding material.

In yet another exemplary embodiment of the present invention, there is provided a lamp comprising an envelope with at least one pinch sealed end portion enclosing a metal lead-through structure being embedded in a material of the end portion and operating in a temperature range. The metal lead-through has a start point and an end point, and comprises elementary sections being connected to and enclosing an angle between each other. The elementary sections have a length smaller than the length leading to a thermal expansion difference between the metal lead-through and the embedding material developing a break in the embedding material.

In a still further exemplary embodiment of the present invention, there is provided a lamp comprising an envelope with at least one pinch sealed end portion enclosing a metal lead-through structure being embedded in a material of the end portion and operating in a temperature range. The metal lead-through has a start point and an end point, and comprises elementary sections. The elementary sections have a length smaller than the length leading to a thermal expansion difference between the metal lead-through and the embedding material developing a break in the embedding material. The elementary sections are connected to and enclose an angle between each other so that a sum of the thermal expansions thereof taken in a direction determined by a straight line drawn between the start point and the end point of the metal lead-through is smaller than the expansion developing a break in the embedding material.

In a halogen or high intensity discharge lamp that may be provided with a pinched seal at one end or at both ends, the use of a metal lead-through structure according to this invention will prevent the glass wall of the pinched seal portion of the lamp tube or envelope to develop thermal or mechanical stresses that otherwise could lead to an early failure of the lamp.

The suggested metal lead-through structure therefore provides a simple configuration for preventing cracks from developing in the pinch seal portion of lamp tubes and envelopes, is easy to combine with the conventional manufacturing steps and therefore compatible with mass production. The glass to metal seal construction according to the invention readily supports different types of lamps and tube configurations.

### BRIEF DESCRIPTION OF DRAWINGS

The invention will now be described in detail with reference to the enclosed drawing, in which

FIG. 1 is a longitudinal cross sectional view of a prior art metal lead-through structure of an exemplary high intensity discharge lamp with a seal foil,

FIG. 2 is an exemplary metal lead-through with two elementary sections between end sections,

FIG. 3 is another metal lead-through with three elementary sections between the end sections,

FIG. 4 is another metal lead-through with five elementary sections between the end sections,

FIG. 5 is a longitudinal cross sectional view of an exemplary high intensity discharge lamp with two metal lead-through structures, and

FIG. 6 is a longitudinal cross sectional view of an exemplary halogen lamp with two metal lead-through structures.

### DETAILED DESCRIPTION OF THE INVENTION

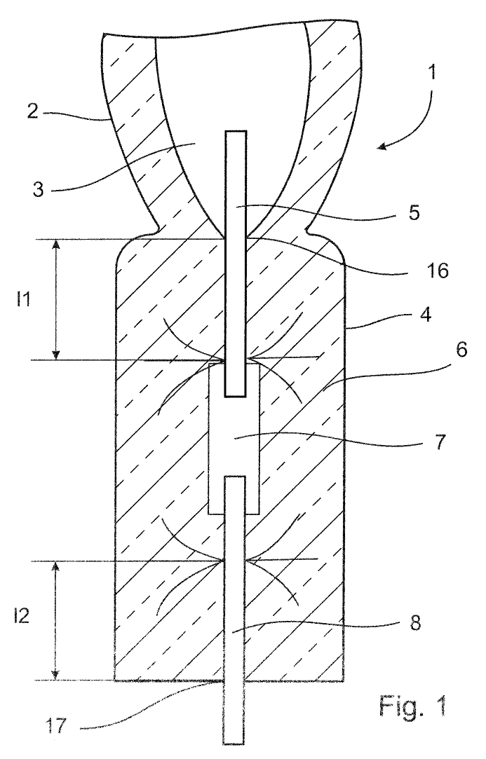

In case of using a quartz glass or a ceramic material, the relatively great difference in the thermal expansion coefficient of the metal and the embedding material has to be taken into account. The quartz glass has a thermal expansion coefficient value of about 0.5 ppm/K, which is extremely low and provides for a great thermal expansion difference in the glass to metal interface. Instead of quartz glass, a ceramic material may also be used for the purposes of the invention with the same effect. A ceramic material, e.g. polycrystalline alumina (PCA Al₂O₃) has a thermal expansion coefficient of 2 to 26 ppm/K. During manufacturing, the metal electrode and current lead wire are introduced into the tube inner volume while the end portion is heated to a temperature above the softening point and the softened glass or ceramic wall of the tube is pressed in order to form a gas tight pinch seal end portion. The metal may be tungsten or molybdenum or a combination of tungsten and molybdenum. During the first cooling down, the glass or ceramic material in contact with the metal wire will be exposed to a compressing mechanical stress, which leads to a partial separation of the metal wire from the glass material. During operation especially during ignition, the electrode is heated to high temperatures in result of which the glass or ceramic material in contact with the metal wire will be exposed to a tensile strain which leads to forming of cracks 6 in the glass or ceramic material as shown in FIG. 1. It has been observed, that the starting points of the cracks concentrate at locations along the metal wire of substantially the same distance 11 and 12 of the seal edge and of each other. This distance is dependent on the difference in the coefficients of thermal expansion of the embedding material (quartz glass or ceramic material) and the metal used. In case of quartz glass and tungsten or molybdenum, this distance is about 2 mm when the operation temperature changes within a range of 500° C. or 600° C. Such a configuration with the combination of a quartz glass and tungsten or molybdenum would have a very short lifetime, therefore additional elements have to be used in practice in order to provide a long term gastight seal

Referring again to FIG. 1, there is shown a partial longitudinal cross sectional view of a high intensity discharge (HID) lamp as used in the automotive industry. The lamp 1 has an arc tube constituted by a sealed lamp envelope 2, made of quartz glass or a ceramic material e.g. polycrystalline alumina. The envelope 2 has a sealed inner volume defining an arc chamber 3 filled with a suitable gas, like argon, krypton or xenon. The arc tube is terminated in a gas tight manner at both ends, and at least one of the ends comprises a pinch seal portion 4. In this configuration, the pinch seal portion 4 encloses an electrode assembly comprising an electrode 5 extending into the arc chamber 3, a lead wire 8 extending outward from the sealed portion 3 for providing electric contact with a power supply (not shown) and an electrically conducting seal foil 7 connecting the lead wire 8 and the electrode 5. The seal foil 7 provides a sealed electric connection through a sealed portion 4 of the arc tube. In FIG. 1, only one half of a HID lamp with a symmetrical structure comprising two substantially identical electrode assemblies is shown. Such prior art seal lead-through structure provides a sufficiently gas tight sealing in the range of the seal foil but it has thermal expansion stress problems in the range of the metal wires, especially in the range of the electrode operating at a higher temperature. It is important in this configuration that the length of the electrode and the current lead wire within the end seal region does not exceed the critical length of about 2 mm in the case of quartz glass. If longer pinched seal portions are required, the length of the seal foil has to be chosen accordingly.

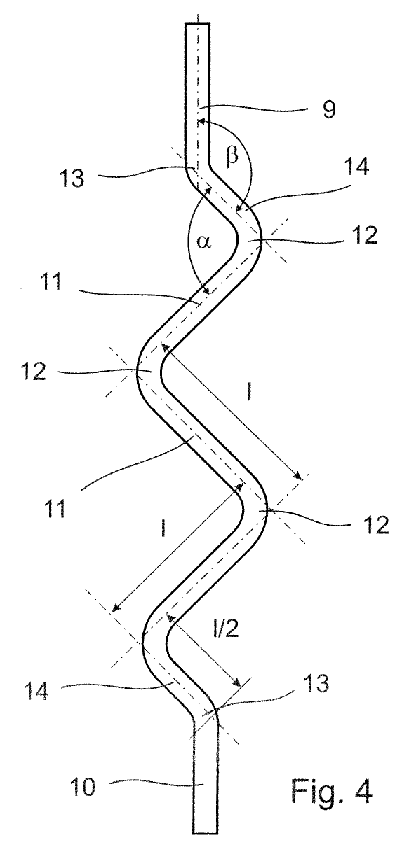

Surprisingly it has been found that using a corrugated metal wire in a pinch sealed end portion of quartz glass or ceramic material, the mechanical stresses developed during thermal load of a lamp will not exceed a critical value if certain dimensional aspects are maintained. Therefore, in an exemplary embodiment of the invention, a metal lead-through construction is suggested in which the lead wire comprises elementary sections connected to and enclosing an angle between each other within the range of the seal portion. The elementary sections have to be connected to each other in a manner that a sum of the thermal expansions thereof taken in a direction determined by a straight line drawn between the start point and the end point of the lead-through is smaller than the expansion developing a break in the embedding material. The start point 16 and the end point 17 of the lead-through are defined as the terminal points of the lead-through within the pinch section. With reference to FIG. 1, the start point may be the intersection point of the lead-through and the inner edge of the pinch section and the end point may be the end of the electrode inside the pinch section. The start point 16 and the end point 17 of the current lead wire can be defined in a similar way. The angle between the elementary sections may be configured to enclose an angle magnitude a of substantially 90 degrees. It should however be appreciated by those skilled in the art that different angles α may be selected as well. The angle between the elementary sections may also be selected in the range of 45 degrees (designated as α in FIG. 4) to 135 degrees (designated as β in FIG. 4).

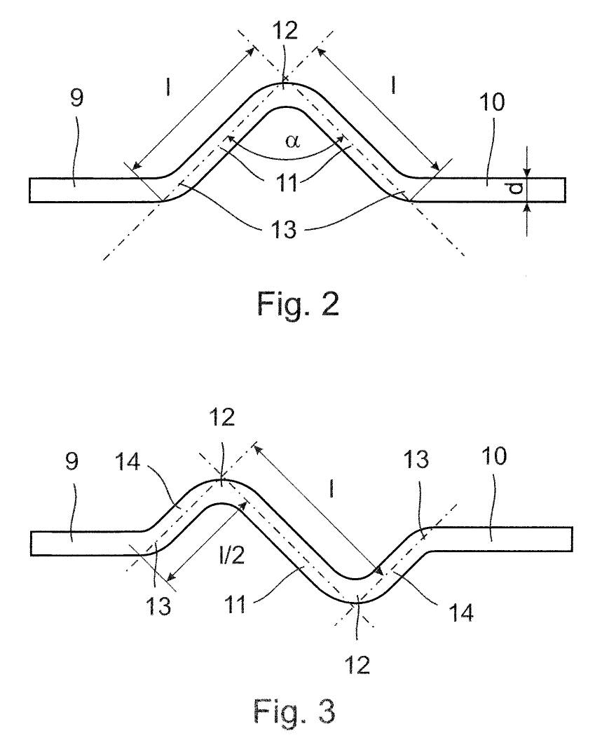

FIGS. 2 to 4 show different lead wire and/or electrode configurations with a straight end section at both ends and at least two elementary sections between the two straight sections. The elementary sections enclose an angle in the range of 45° to 135°. Referring first to FIG. 2, there is shown a lead wire or electrode configuration with two end straight sections 9, 10, two elementary sections 11, and three curved sections 12, 13 between the straight sections. The length l of the elementary sections 11 is substantially equal to each other and to the length of the end straight sections 9, 10 within the glass end seal portion. The elementary sections 9, 10, 11 have a substantially straight form with a length within the range of the seal portion not exceeding the critical length resulting from the different thermal expansion coefficients of the metal wire and the sealing material. The length of the substantially straight elementary sections of the metal lead-through (current lead and/or electrode wire) has a length, which is preferably not greater than 2 mm in the event that the embedding material is quartz glass. It has namely been found that in case of sealing of quartz glass and a metal wire of tungsten or molybdenum, the critical length due to the different thermal expansion coefficients of the metal wire and the sealing material is about 2 mm if the operating temperature of the lead-through structure changes in the range of 500 to 600° C. By selecting a length which is not greater than 2 mm, excessive mechanical stress that develops at high operating temperatures and could lead to cracks in the embedding material of the seal end portion may be avoided. As it can be seen in the embodiment shown in FIG. 2, the neighboring intermediate elementary sections 11 of the metal wire may be positioned substantially at right angle with respect to each other. The angle between the end sections 9, 10 and the neighboring intermediate elementary sections 11 of the metal wire may be about 135 degree. This metal wire configuration is asymmetric with only one lateral extension that can be used in case of short glass/ceramic to metal interfaces.

FIGS. 3 and 4 show further examples of a metal (current lead and/or electrode) wire with a symmetrical configuration comprising at least one longer intermediate elementary section 11 and two shorter intermediate elementary sections 14 between the two end sections 9, 10. This configuration has two lateral extensions, which is smaller than that of the one sided configuration shown in FIG. 2. All other dimensions are substantially the same as already described in connection with FIG. 2. As it is clear from FIG. 4, the number of the longer intermediate elementary sections 11 can be chosen in accordance with the specific application requirements and practically any required length may be provided. The metal wire configurations of the invention allow a current lead wire of a length greater than the length of the usual constructions to be used.

According to another exemplary embodiment of the invention, in a glass/ceramic to metal seal construction, the metal lead-through wire has two straight end sections and an intermediate section comprising curved elementary sections, such as formed of a spiral having a diameter not exceeding the critical length resulting from the different thermal expansion coefficients of the metal wire and the glass sealing material. The diameter of the spiral used in this configuration is preferably not greater than 2 mm when the embedding material is quartz glass.

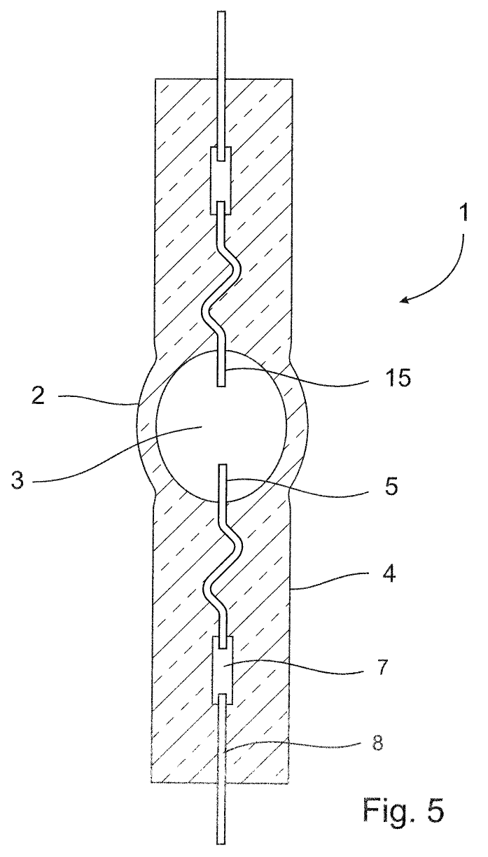

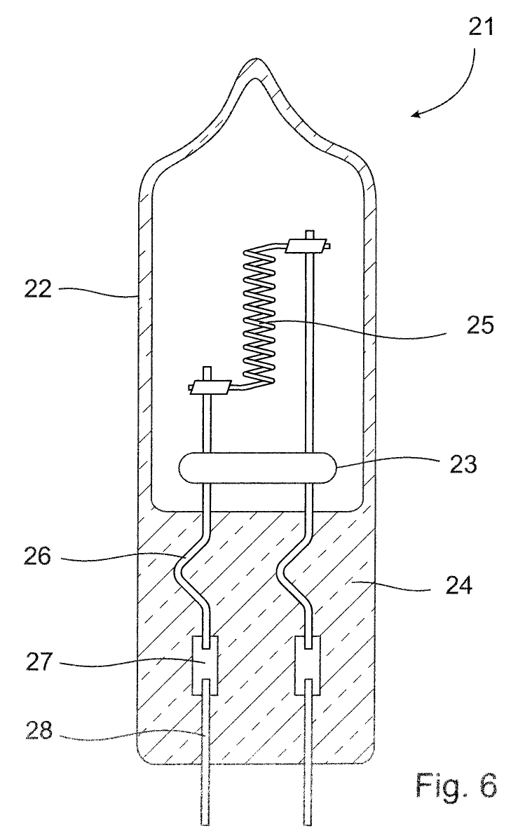

The following figures depict different applications of the metal lead-through wire configurations shown in FIG. 2 to 4 that may be used in connection with a lamp operating at high temperatures. FIG. 5 shows a high intensity discharge lamp (HID) and FIG. 6 illustrates a halogen lamp with two lead-through structures embedded in an end seal of the lamps.

Referring now to FIG. 5, there is shown a cross sectional top view of a high intensity discharge (HID) lamp as used in the automotive industry. The lamp 1 has an arc tube in form of a sealed lamp envelope 2, made of quartz glass or ceramic material. The envelope 2 has a sealed inner volume defining an arc chamber 3 filled with a suitable gas, like argon, krypton or xenon. The arc tube is terminated at both ends in a gas tight manner with at least one of the termination comprising a pinch sealed portion 4. In this configuration, the pinch seal portion 4 encloses a lead-through structure comprising a corrugated electrode 15 extending into the arc chamber 3, a straight lead wire 8 extending outward from the sealed portion 3 for providing electric contact with a power supply (not shown) and an electrically conducting seal foil 7 connecting the lead wire 8 and the electrode 15. The seal foil 7 provides a sealed electric connection through a sealed portion 4 of the arc tube. Because of the higher operating temperature of the electrode, its form has been selected according to an embodiment of the invention.

In the last example of FIG. 6, a halogen lamp 21 is shown with an envelope 22 defining an inner volume and made from quartz glass, a sealed end portion 24 and two metal lead-through structures comprising internal current lead wires 26, seal foils 27 and external current lead wires 28 as already shown and discussed in connection with FIG. 5. The inner ends of the current lead wires 26 embedded in the pinch seal are connected to a filament 25 preferably of tungsten. In order to ensure a defined geometrical position of the two current lead wires 26 a bridge member 23 of an insulating material, preferably of glass may be used. The metal lead-through wire configuration of this example is asymmetric with only one lateral extension that can be used in case of short glass to metal interfaces as none of the straight sections within the seal portion may exceed in length 2 mm.

The invention is not limited to the shown and disclosed embodiments, but other elements, improvements and variations are also within the scope of the invention. For example, it is clear for those skilled in the art that beside the shown forms of curved metal wires any other forms may be suitable. Also the geometry and structure of the metal wires used in the shown lamps may be different from the shown examples.

1. A metal lead-through structure being embedded in an embedding material and operating in a temperature range, the metal lead-through having a start point and an end point, and comprising
elementary sections being connected to and enclosing an angle between each other;
the elementary sections having a length smaller than the length leading to a thermal expansion difference between the metal lead-through and the embedding material developing a break in the embedding material.

2. The structure of claim 1, in which the elementary sections enclose an angle magnitude so that a sum of the thermal expansions thereof taken in a direction determined by a straight line drawn between the start point and the end point of the metal lead-through is smaller than the expansion developing a break in the embedding material.

3. The structure of claim 1, in which the elementary sections are connected to each other in a manner that the metal lead-through follows a corrugated line.

4. The structure of claim 1, in which the elementary sections enclose an angle of substantially 90 degrees.

5. The structure of claim 1, in which the elementary sections enclose an angle in a range of 45 degrees to 135 degrees.

6. The structure of claim 1, in which the embedding material is quartz glass.

7. The structure of claim 1, in which the embedding material is a ceramic material.

8. The structure of claim 1, in which the metal lead-through is made from tungsten.

9. The structure of claim 1, in which the metal lead-through is made of molybdenum.

10. The structure of claim 1, in which the metal lead-through operates in the temperature range of at least 500 degrees of Celsius.

11. The structure of claim 1, in which the metal lead-through operates in the temperature range of at least 600 degrees of Celsius.

12. The structure of claim 1, in which the elementary sections have a length not greater than 2 millimeters.

13. The structure of claim 1, in which the elementary sections are straight.

14. The stricture of claim 1, in which the elementary sections are curved.

15. A structure of a metal lead-through being embedded in an embedding material and operating in a temperature range, the metal lead-through having a start point and an end point, and comprising
elementary sections;
the elementary sections having a length smaller than the length leading to a thermal expansion difference between the metal lead-through and the embedding material developing a break in the embedding material; and
the elementary sections being connected to and enclosing an angle between each other so that a sum of the thermal expansions thereof taken in a direction determined by a straight line drawn between the start point and the end point of the metal lead-through is smaller than the expansion developing a break in the embedding material.

16. The structure of claim 15, in which the elementary sections are straight, and are connected to each other so that the metal lead-through follows a corrugated line.

17. The structure of claim 15, in which the elementary sections enclose substantially 90 degrees.

18. The structure of claim 15, in which the embedding material is selected from the group of quartz glass and ceramic material, and the lead-through is made from at least one of the metals selected from the group of tungsten and molybdenum.

19. The structure of claim 18, in which the metal lead-through operates in the temperature range of at least 500 degrees of Celsius, and the elementary sections have a length of at most 2 millimeters.

20. A lamp comprising an envelope with at least one pinch sealed end portion enclosing a metal lead-through structure being embedded in a material of the end portion and operating in a temperature range, the metal lead-through having a start point and an end point, and comprising
elementary sections being connected to and enclosing an angle between each other;
the elementary sections having a length smaller than the length leading to a thermal expansion difference between the metal lead-through and the embedding material developing a break in the embedding material.

21. A lamp comprising an envelope with at least one pinch sealed end portion enclosing a metal lead-through structure being embedded in a material of the end portion and operating in a temperature range, the metal lead-through having a start point and an end point, and comprising
elementary sections;
the elementary sections having a length smaller than the length leading to thermal expansion difference between the metal lead-through and the embedding material developing a break in the embedding material; and
the elementary sections being connected to and enclosing an angle between each other so that a sum of the thermal expansions thereof taken in a direction determined by a straight line drawn between the start point and the end point of the metal lead-through is smaller than the expansion developing a break in the embedding material.
